(19) United States
(12) Patent Application Publication
(10) Pub. No.: US 2003/0072442 A1
(43) Pub. Date: Apr. 17, 2003

(54) Cisponentiation method, software, and device for exponentiation

(76) Inventors: George Robert Blakley, Austin, TX (US); Rajat Datta, Round Rock, TX (US); Oscar R. Mitchell, Pflugerville, TX (US); Kyle Stein, Round Rock, TX (US)

Correspondence Address: THOMPSON & KNIGHT L.L.P., PATENT PROSECUTION DEPARTMENT, 98 SAN JACINTO BLVD., SUITE 1200, AUSTIN, TX, 78701, US

(21) Appl. No.: 10/260,744

(22) Filed: Sep. 30, 2002

Related U.S. Application Data
(60) Provisional application No. 60/326,250, filed on Oct. 1, 2001.

(51) Int. Cl. H04K 1/00

(52) U.S. Cl. 380/28

(57) ABSTRACT

A method, software, and device for encrypting data, exchanging keys, and processing data that includes exponentiating by iteratively cisponentiating according to cisponentiator C(G, E, B, R, m)=G^{E}BR mod m, wherein G is a fleeting multiplicand base, E is an enduring cisponent, B is a recurring multiplier, R is an enduring factor, and m is a persistent modulus. E may be a fixed characteristic of the cisponentiator. E may also be a power of 2. R may be fixed. In one of many possible combinations, E is a fixed characteristic of the cisponentiator, while R is fixed. In that case also, E may be a power of 2. Modulus m may be fixed. In one of many possible combinations, E is a fixed characteristic of the cisponentiator, R is fixed, and m is fixed. As one of many alternatives, data may be encrypted using asymmetric encryption.

### CROSS-REFERENCE TO RELATED APPLICATIONS

This application claims the benefit of the U.S. Provisional Application identified by Attorney Docket No. 501143.000017 and Serial No. 60/326,250, entitled “Method for Squaring” and filed Oct. 1, 2001. The benefit of 35 U.S.C. § 120 is claimed for that commonly owned provisional application. But the contents of that provisional application are not necessarily identical to the contents of this application.

Any references cited hereafter are incorporated by reference to the maximum extent allowable by law. To the extent a reference may not be fully incorporated herein, it is incorporated by reference for background purposes and indicative of the knowledge of one of ordinary skill in the art.

### BACKGROUND OF THE INVENTION

1. Field of the Invention

The field of this invention is communications and cryptography.

2. Description of Related Art

Many applications depend upon calculation of exponentiations. One particularly direct approach to calculating exponentiations, a redoubling of exponents, is illustrated by the following example:

Task: Calculate x¹⁶

Step 1: x²=x×x

Step 2: x⁴=x²×x²

Step 3: x⁸=x⁴×x⁴

Step 4: x¹⁶=x⁸×x⁸

But that approach is limited to calculating xⁿ where n is a power of 2. A more tedious but comprehensive approach is the brute force method illustrated by the following example:

Task: Calculate x¹⁹

Step 1: x²=x×x×1

Step 2: x⁴=x²×x²×1

Step 3: x⁹=x⁴×x⁴×x

Step 4: x¹⁹=x⁹×x⁹×x

One weakness with the brute force approach is many additional multiplications (by x) may be necessary to calculate xⁿ where n is not a power of 2, especially where n is slightly less than an integer power of 2. For example:

Task: Calculate x⁶²

Step 1: x³=x×x×x

Step 2: x⁷=x³×x³×x

Step 3: x¹⁵=x⁷×x⁷×x

Step 4: x³¹=x¹⁵×x¹⁵×x

Step 5: x⁶²=x³¹×x³¹×1

An ancillary approach, called the “sliding window” approach, mitigates the problem of many repeated multiplications (by x) using a stored collection of pre-calculated values. For example, using a sliding window of width two to calculate x⁶²:

Task: Calculate x⁶²

Step 1(setup): x²=x×x

x³=x²×x

Step 2: x¹⁵=((x³)²)²×x³

Step 3: x⁶²=((x¹⁵)²)²×x²

In general in the sliding window approach the low powers of x are calculated and stored in the setup step. Here, “low powers” means those less than xˆ (2ˆ w), where w is the window width. Then each step involves squaring the intermediate value w times and multiplying it by the appropriate low power of x.

Note that the brute force approach described above is the degenerative case of sliding window with window width 1.

The benefit of using a sliding window approach can be substantial. For example, calculating xˆ (2ˆ n), requires about n calculations, then calculating xˆ (2ˆ n−1) would typically require about 2n calculations, and a typical n-bit exponent would require on average 3n/2 calculations. A width 4 sliding window approach would calculate the same exponentiation in approximately 5n/4 calculations.

What is needed is a mechanism for efficiently reducing the number of calculations required to calculate x^{k} where k is a power of 2, and thus the number of calculations required to calculate x^{k} where k is any integer.

Montgomery modular multiplication facilitates repetitive modular reduction operations, mod N, where N is an odd integer constant. Public key cryptography depends heavily on arithmetic operations modulo a multiple-precision odd integer. So the performance of a public key cryptosystem depends heavily on the speed with which it executes those operations. Multiplications and divisions have particularly large influences on processing time. The Montgomery method particularly facilitates repeatedly executing multiplications. The Montgomery method is a method for computing multiple-precision modular multiplication with a processing cost of about two multiple-precision multiplications. Multiple-precision modular reduction usually has poor performance compared with multiple-precision multiplication, so the Montgomery method can significantly improve performance.

Suppose two numbers are to be multiplied. First, they are each transformed into Montgomery space by reducing each modulo m. Then the Montgomery multiplication is carried out, and its result is inversely transformed out of Montgomery space. The transformation and inverse transformation each have a processing load of about one multiple-precision multiplication. Consequently, modular exponentiation suffers lower overhead due to the Montgomery conversion and the inverse Montgomery conversion because it carries out modular multiplications repeatedly and therefore it can be realized by a fast implementation. The Montgomery method can benefit many public key algorithms, including RSA, that use modular exponentiation, S=A^{d} mod N, as their basic operation. But the Montgomery method will not necessarily lead to efficient implementation if only some multiplications are required due to transform and inverse transform overhead.

Various Montgomery modular multiplication methods are known. See, for example, Peter L. Montgomery, “Modular Multiplication Without Trial Division”, Mathematics of Computations, vol. 44, no. 170, pp.519-521, April 1985; Stephen R. Dussé and Burton S. Kaliski, Jr., “A Cryptographic Library for the Motorola DSP 56000”, Advances in Cryptography, Proc Eurocrypt'90, Lecture Notes In Computer Science no. 473, pp. 230-244, Springer-Verlag, 1990; and the methods of U.S. Pat. No. 4,514,592 to Miyaguchi, U.S. Pat. No. 5,101,431, to Even, U.S. Pat. No. 5,321,752 to Iwamura, U.S. Pat. No. 5,448,639, to Arazi, and U.S. Pat. No. 5,513,133 to Gressel.

In addition, U.S. Pat. No. 6,185,596 to Hadad et al. discloses a microelectronic apparatus operative to perform a sequence of interleaved Montgomery type multiplications and squaring operations.

In cryptography and many other fields, it is often necessary to have a source of pseudorandom numbers. Many methods and devices utilized at present produce linear congruential pseudorandom number streams. The linearity of these streams has disadvantages in protecting against cryptographic analysis, and nonlinear congruential pseudorandom streams are sometimes preferred. Repeated modular exponentiation is one accepted way of producing such nonlinear congruential pseudorandom streams.

### BRIEF SUMMARY OF THE INVENTION

The present invention includes method, software, and device embodiments for encrypting data, exchanging keys, and processing data that includes exponentiating by iteratively cisponentiating (“cisponentiation” is defined below) according to cisponentiator C(G, E, B, R, m)=G^{E}BR mod m, wherein G is a fleeting multiplicand base, E is an enduring cisponent, B is a recurring multiplier, R is an enduring factor, and m is a persistent modulus. E may be a fixed characteristic of the cisponentiator, resulting in C_{E}(G, B, R, m)=C(G, E, B, R, m)=G^{E}BR mod m. E may also be a power of 2. R may be fixed, resulting in C_{R}(G, E, B, m)=C(G, E, B, R, m)=G^{E}BR mod m. In one of many possible combinations, E is a fixed characteristic of the cisponentiator, while R is fixed, resulting in C_{ER}(G, B, m)=C(G, E, B, R, m)=G^{E}BR mod m. In that case also, E may be a power of 2. Modulus m may be fixed, resulting in Cₘ(G, E, B, R)=C(G, E, B, R, m)=G^{E}BR mod m. In one of many possible combinations, E is a fixed characteristic of the cisponentiator, R is fixed, and m is fixed, resulting in C_{ERm}(G, B)=C(G, E, B, R, m)=G^{E}BR mod m. As one of many alternatives, data may be encrypted using asymmetric encryption.

### BRIEF DESCRIPTION OF THE DRAWINGS

The following drawings form part of the present specification and are included to further demonstrate certain aspects of the present invention. The figures are not necessarily drawn to scale. The invention may be better understood by reference to one or more of these drawings in combination with the detailed description of specific embodiments presented herein.

FIG. 1 (including FIGS. 1A and 1B) shows a flow of a modular exponentiation process utilizing a cisponentiator, in accordance with an embodiment of the present invention.

FIG. 2 shows a flow of a cisponentiator utilizing a Montgomery multiplier, in accordance with an embodiment of the present invention.

FIG. 3 (including FIGS. 3A and 3B) describes a device which is a pipelined redoubling cisponentiator, in accordance with an embodiment of the present invention.

### DETAILED DESCRIPTION OF PREFERRED EMBODIMENTS

Part 1—The Four Duration Scales

This approach provides hardware and software design activities by means of which practical fast arithmetic operations such as exponentiation can be implemented.

It is possible because several arithmetical operations deal with quantities which exist on different time scales.

In the process of exponentiation, for example, there are four readily discernible time scales: fleeting, recurring, persistent and enduring.

More specifically, suppose that there is a fixed positive integer t so large that every x, every d and every m appearing in the next few paragraphs is smaller than 2^{t}. That is, x, d, and m are t-bit numbers.

Consider the process which, given any positive integers x, d, m which are appropriately small in the sense described immediately above, produces the power x^{d} mod m.

The well known binary method of raising x to a power (see, Knuth, The Art of Computer Programming, Third Edition, Vol. II, pp. 461-485, Addison Wesley Longman, 1997) uses a process of fewer than 2t multiplications to produce a succession {y<1>, y<2>, . . . , y<s>} of s partial products, the y<i>, where:

s is smaller than 2t

every y<i> is a positive integer smaller than 2^{t}

y<0>=x

y<s>=x^{d} mod m

every y<j> satisfies

either y<j+1>=y<j>*y<j> mod m or y<j+1>=y<j>*x mod m depending on the bits of d.

Suppose that an organization computes the power x^{d} mod m many times, based on various values of x, d, m, but always subject to the constraint that each such quantity is less than 2^{t}. This disclosure is generally constrained in that each x, d, and m are less than 2^{t}.

In this activity, the large positive integer t is ENDURING. It does not change as x and d and m change.

Though not enduring, the quantities d and m are PERSISTENT throughout the calculation of a particular x^{d} mod m, in the sense that they both occur in, and are essential to, every multiplication involving the y<j> even as j changes, and as each successive y<j> is created and—shortly thereafter—destroyed.

Though not persistent, the quantity x is RECURRING throughout the calculation of a particular x^{d} mod m. It isn't necessary to the production of every single y<j>. But from time to time, even up to the very last j, the quantity x can again be required.

No y<j> is recurring. Each one is created but very soon thereafter destroyed. Each y<j> is FLEETING.

Part 2—Multary Operators

Universal algebra (George Gratzer, Universal Algebra, pp. 1-7, D. Van Nostrand Company, Inc., 1968) has developed a viewpoint and a terminology which is integral to the discussion below.

A MULTARY OPERATION (or equivalently, MULTARY COMPOSITION, N-ARY OPERATION, or N-ARY COMPOSITION) on a set S is a function whose domain (i.e., set of actual inputs) is a Cartesian product of a number of copies of S, and whose codomain (i.e., set of possible outputs) is S.

In other words a multary operation on S is a way of combining the entries on a list of members of S in an arithmetical fashion so as to produce another member of S.

Things become clearer by considering the first few kinds of multary operations, namely NULLARY, UNARY, BINARY, TERNARY, QUATERNARY and PENTARY operations.

A nullary (or 0-ary) operation accepts inputs from the product of zero copies of S. In other words it has just one input, the empty set, and therefore just one output, call it x.

So a nullary operation on S just amounts to a single member x of S. If S is a set of numbers, then 0 and 1 are usually the only members of S that are actually called nullary operations.

A unary (or 1-ary) operation on S accepts entries from the Cartesian product of one copy of S. In other words, it's a function from S to S. If S is a set of numbers, two common unary operations are “reciprocal” and “negative.” So

reciprocal(x)=1/x and

negative(y)=−y.

In particular

reciprocal(5.0)=0.2

negative(5.0)=−5.0

Other unary operations are sin, cos, tan, ln, square, cube, etc.

A binary (or 2-ary) operation accepts inputs from the Cartesian product of two copies of S. It's a function from S×S to S. In other words, it's an operations table, like the addition table or the multiplication table. Binary operations are extremely diverse. Subtraction is also a binary operation. Division would be, too, if division by zero were possible. Restriction of “divide” to the set S of strictly positive numbers resolves that problem, so divide can be a binary operation. Other examples are max, min, gcd, lcm, the function f(x,y)=x²+y², and others seen below.

A ternary (or 3-ary) operation accepts inputs from the Cartesian product S×S×S of three copies of S, and produces an output belonging to S. For example,

h(u, v, w)=uˆ (vˆ w) or

g(a, b, c)=a²+b²+c².

So

h(4, 3, 2)=262,144

g(4, 3, 2)=29

A good example of a quaternary (or 4-ary) operation—which accepts a list of four numbers as an input and produces a number as its output—is the application to two by two matrices of the ordinary determinant function

$$S o \begin{matrix}d ( p , q , r , s ) = \vert \begin{matrix}p & q \\ r & s\end{matrix} \vert = p * s - q * r . \\ d ( 2 , 3 , 4 , 5 ) = \vert \begin{matrix}2 & 3 \\ 4 & 5\end{matrix} \vert = 2 * 5 - 3 * 4 = - 2\end{matrix}$$

A pentary (or 5-ary) operation accepts a list of five numbers as an input and produces a number as its output.

Part 3—Exponentiation in This Terminology

Consider brute force exponentiation as a succession of quaternary operations of the form

f(x, y, m, r)=(xˆ 2)(y)(r) mod m.

Here

x is real and fleeting,

y is real and recurring,

m is real and persistent, and

r is real and enduring.

Therefore

x mod m is a residue and is fleeting

y mod m is a residue and is recurring

r mod m is a residue and is persistent

xˆ 2 is real and fleeting

(xˆ 2)(y) is real and fleeting

(xˆ 2)(y)(r) is real and fleeting

xˆ 2 mod m is a residue and is fleeting

(xˆ 2)(y) mod m is a residue and is fleeting

(xˆ 2)(y)(r) mod m is a residue and is fleeting

This is one example of the use of one or more multary operations of various types to effect yet another multary operation of yet another type.

In fact the expression above can be viewed in numerous different ways, ranging from the rather serial:

i) use a unary squaring operation on a (fleeting) real number x,

then a binary reduction operation on a (fleeting) real number xˆ 2 (modulo m )

then a ternary reduced (modulo m) product operation on a (fleeting) residue xˆ 2 mod m and a (recurring) residue y mod m

then a ternary reduced (modulo m) product operation on a (fleeting) residue (xˆ 2)(y) mod m and a (persistent) residue r mod m

to the very synoptic:

ii) perform a quaternary operation

f(x, y, m, r)

this quaternary operation amounts to a reduced (modulo m) parameterized (by r) binary operation whose action is<x mod m, y mod m>|→(xˆ 2)(y)(r) mod m

This operation could be the exponentiation workhorse. To raise a 1000 bit base to a 1000 bit power would take only 1000 applications of f(x, y, m, r).

Contrast this with the use of Montgomery multiplication 1500 times (for a typical 1000 bit number).

Conventional Montgomery multiplication is both a case of—and prior art with respect to—the general approach, described herein, to arithmetic by means of parameterized (by an enduring r) multary operations (modulo a persistent m).

Another obviously desirable case—compatible with sliding window methodologies of width 2—would be four operations taking (x, y, m, r) to, respectively

(xˆ 4)(r) mod m

(xˆ 4)(y)(r) mod m

(xˆ 4)(yˆ 2)(r) mod m, and

(xˆ 4)(yˆ 3)(r) mod m

for fleeting x, recurring y, persistent m, and enduring r.

The general approach will be apparent to those of skill in the art.

Part 4—Cisponentiation

As used herein, cisponentiation is a facilitator to exponentiation. Etymologically, the Latin prefix cis roughly means “up to” and was selected because cisponentiation raises a number to a power less than the desired exponent of exponentiation.

Definition: A cisponentiator is a multary operator which produces the output G^{E}BR mod m where:

G is a multiplicand base

E is a cisponent

B is a multiplier

R is a reduction factor

m is a modulus

In the general case, a cisponentiator is a pentary operator, C(G, E, B, R, m), whose five inputs are of the following durations:

G—fleeting

E—enduring

B—recurring

R—enduring

m—persistent

The differing durations of the inputs to a general cisponentiator allow the operator to be considered of lower multary order by considering a subset of the inputs as fixed. E may be a fixed characteristic of the general cisponentiator, resulting in the quaternary operator C_{E}(G, B, R, m)=C(G, E, B, R, m)=G^{E}BR mod m. For example in a cubing cisponentiator C₃(G, B, R, m)=G³BR mod m. E may also be a power of 2, which allows an evident implementation. For example an 8-power cisponentiator may be realized with successive squarings (exponent redoubling) C₈(G, B, R, m)=G⁸BR mod m=((G²)²)²BR mod m.

R may be fixed, resulting in the quaternary operator C_{R}(G, E, B, m)=C(G, E, B, R, m)=G^{E}BR mod m. For example if a Montgomery type technique is used, R may be a negative power of two related to the size of the other inputs: C_{R}(G, E, B, m)=G^{E}B2^{-t} mod m.

In one of many possible combinations, E is a fixed characteristic of the cisponentiator, while R is fixed, resulting in the ternary operator C_{ER}(G, B, m)=C(G, E, B, R, m)=G^{E}BR mod m. In that case also, E may be a power of 2. Modulus m may be fixed, resulting in the quaternary operator Cₘ(G, E, B, R)=C(G, E, B, R, m)=G^{E}BR mod m. In one of many possible combinations, E is a fixed characteristic of the cisponentiator, R is fixed, and m is fixed, resulting in the binary operator C_{ERm}(G, B)=C(G, E, B, R, m)=G^{E}BR mod m.

Definition: A redoubling cisponentiator is one in which the enduring cisponent E is a power of 2 (E=2^{s}). The power of 2, s, is referred to as the redoubling depth of the cisponentiator.

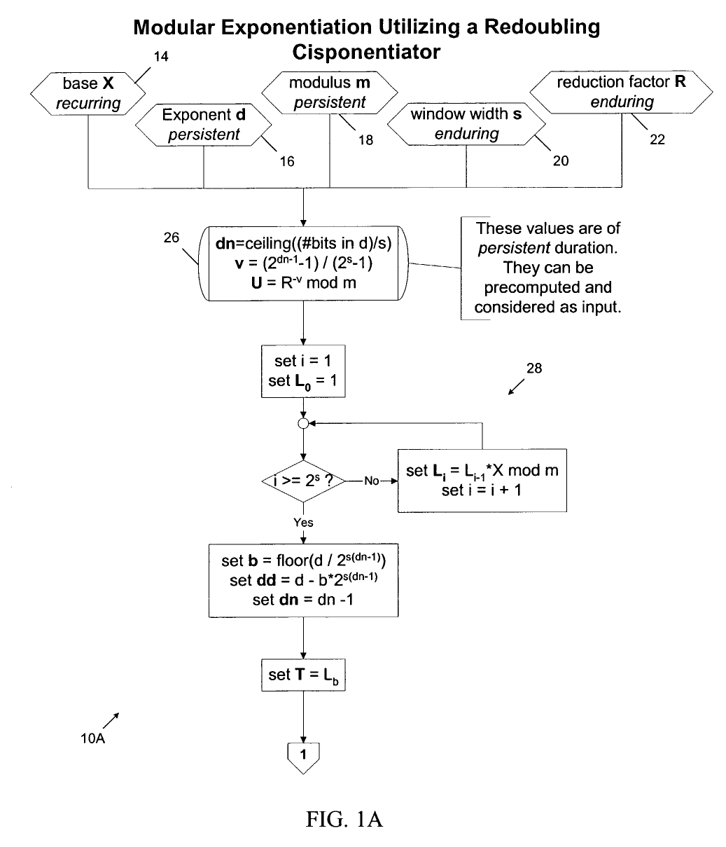

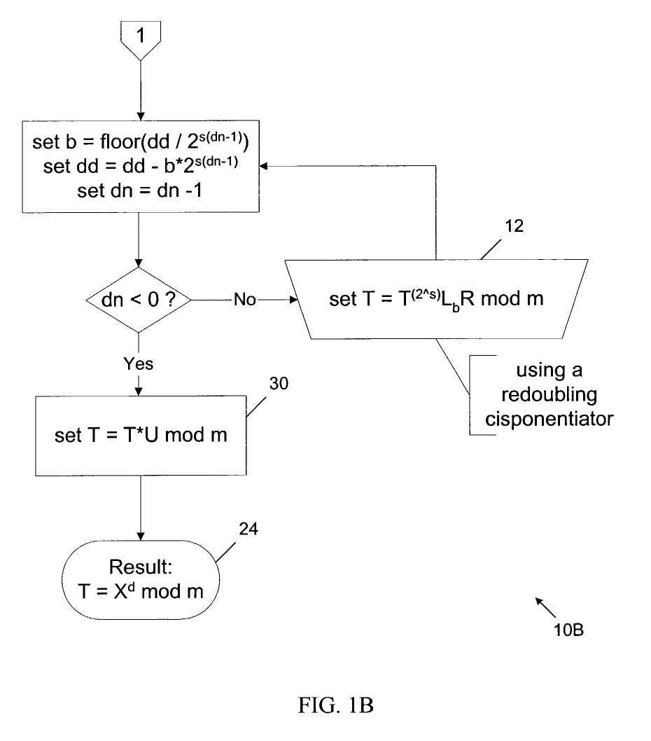

The FIG. 1 (including FIGS. 1A and 1B) flow describes a process (10) (including parts 10A and 10B) for modular exponentiation utilizing a redoubling cisponentiator (12). It takes a base X (14), an exponent d (16), and a modulus m (18) as input as well as parameters s (20) and R (22) as the enduring redoubling depth and reduction factor of the cisponentiator respectively. It produces X^{d} mod m as output (24).

The first block (26) in the flow describes values which can be precomputed. These values depend on the persistent exponent d (16) and enduring parameters s (20 and R (22). They change only as often as the exponent (16) and can therefore be computed once and stored for later reference.

The initial loop (28) calculates the first 2^{s} powers of X (14), L₁=X¹ mod m, i=0 . . . 2^{s}−1. These recurring values are stored for later reference.

The remainder of the algorithm parses the exponent d (16), from the left, s bits at a time. (In some embodiments, parsing can proceed from the right.) The value of the s bits provide an index to the L array which provides the multiplier input to the cisponentiator (12). The multiplicand base is the fleeting accumulator value T. The accumulator T is iteratively updated to be the output of a redoubling cisponentiator (12) with redoubling depth s (20).

The value of T, upon exit from the second loop (12), is X^{d}R^{v} mod m. This is multiplied by U=R^{-v} mod m (30) to get the final result (24).

The redoubling cisponentiator (12) utilized in this method is of arbitrary implementation. It only need have the “black box” property of producing the cisponentiator output G^{(2ˆ s)}BR mod m, given inputs G, s, B, R, and m, any subset of which may be fixed. The cisponentiator may produce this result by a direct method or by combination of component methods. The following section describes a specific example of a redoubling cisponentiator which utilizes the component method of Montgomery multiplication.

Part 5—Utilizing a Montgomery Multiplier

Given k-bit numbers X and Y and a k-bit odd modulus M, the Montgomery multiplier gives an output of XY2^{-k} mod M.

Montgomery multipliers can be used to build a redoubling cisponentiator with reduction factor R=2^{-k(2ˆ s)} mod M, where k is the bit width of the Montgomery multiplier, s is the redoubling depth, and M is the modulus of both operators.

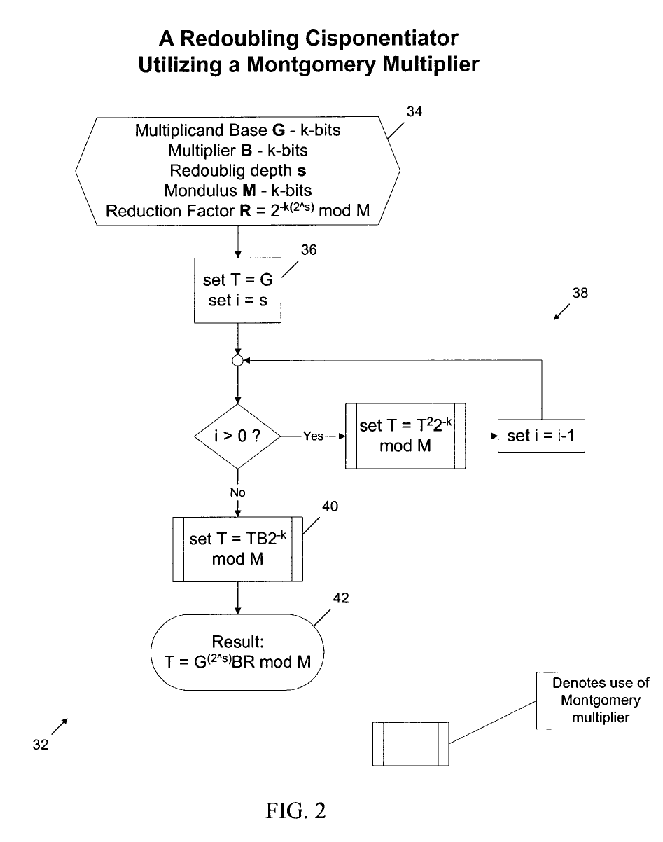

The FIG. 2 flow describes such a cisponentiator. Its inputs G, B, R, and M (34) are k-bit numbers. The reduction factor R is a function of k and the redoubling depth s. The algorithm starts by setting (36) the accumulator value T to the multiplicand base G. Then a Montgomery multiplier (38) is used s successive times, each time setting T=T²2^{-k} mod M. Upon exit from the loop T is equal to G^{2ˆ s}2^{-k((2ˆ s)-1)} mod M. Finally, T is set to TB2^{-k} mod M (40) which is equal to the final result G^{2ˆ s}B2^{-k(2ˆ s)} mod M (G^{2ˆ s}BR mod M) (42).

Part 6—A Redoubling Cisponentiator Device

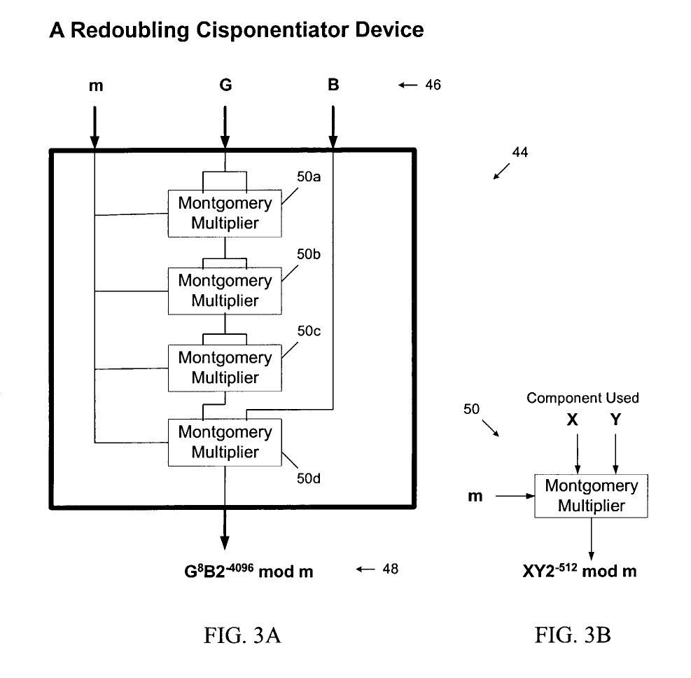

FIG. 3 (including FIGS. 3A and 3B) shows a high level diagram of a device (44) that implements a redoubling cisponentiator. For simplicity a cisponentiator with redoubling depth 3 is shown, but the technique of adding depth by chaining more Montgomery multipliers (50) should be evident. Again for simplicity, the device takes input and outputs numbers of bit-width 512, but using components of different width should also be evident. Inputs (46) to the device are 512-bit numbers G, B, and odd number m. Output (48) is the 512-bit number G⁸B2⁻⁴⁰¹⁶ mod m. The device (44) uses component Montgomery multiplier devices (50). Each Montgomery multiplier (50) takes three inputs, two multiplicands and a modulus, and outputs the Montgomery product of the multiplicands. For this specific case of 512-bit multipliers, [X, Y, m]|→XY2⁻⁵¹² mod m. All of the multipliers shown take m as the modulus input. The first multiplier (50a) in the series takes G as input for both multiplicands. Its output is G₁=G²2⁻⁵¹² mod m. The second multiplier (50b) takes G₁ as input for both multiplicands. Its output is G₂=G₁²2⁻⁵¹² mod m=G⁴2⁻¹⁵³⁶ mod m. The third multiplier (50c) takes G₂ as input for both multiplicands. Its output is G₃=G₂²2⁻⁵¹² mod m=G⁸2⁻³⁵⁸⁴ mod m. The final multiplier (50d) takes G₃ as one multiplicand input and B as the other multiplicand input. It outputs G₄=G₃B2⁻⁵¹² mod m=G⁸B2⁻⁴⁰⁹⁶ mod m. G₄ is the output (48) of the device.

Part 7—Glossary

“=” means equality or congruence, depending on the context. This is clear to typical practitioners of this technical area.

“Algorithm” means a process for completing a task. An encryption algorithm is the process, typically with mathematical characteristics, to encrypt and decrypt messages.

“Asymmetric key cipher” means a public-private key cryptography system.

“Authentication” means the process of verifying that a file or message has not been altered en route from the distributor to the recipient(s).

“Cipher” means a cryptographic algorithm used to encrypt and decrypt files and messages.

“Ciphertext” means the disguised (or encrypted) file or message.

“Cryptography” is the art of creating and using cryptosystems.

“Decryption” means any process to convert ciphertext back into plaintext. Decrypting is synonymous to decoding.

“Encryption” means any process to convert plaintext into ciphertext. Encrypting is synonymous to encoding.

“Key” means a collection of bits, usually stored in a file, which is used by a cryptographic algorithm to encrypt or decrypt a message.

“Key exchange” means the exchange of keys between two or more parties for use along with cryptographic algorithms to encrypt data.

“Plaintext” means the original message or file. After a file or message has been encrypted and then decrypted you should end up with the original file or message.

“Private key” means the private key of a public-private key cryptosystem. This key is used to digitally sign outgoing messages and is used to decrypt incoming messages.

“Public key” means the public key of a public-private key cryptosystem. This key is used to confirm digital signatures on incoming messages or to encrypt a file or message so that only the holder of the private key can decrypt the file or message.

“Public key cryptosystem” means a family of asymmetric encryption algorithms in which it is infeasible to derive one key from the other.

“Public-private key cryptosystem” means a cryptosystem that uses two different keys to encrypt and decrypt messages and files. The two keys are mathematically related to each other, but deriving one key from the other is infeasible. One key is a public key and one key is a private key. The public key is usually distributed to other users, and the private key is usually kept secret.

“RSA exponentiation” means the process for both encryption and decryption in the RSA public-key process. It entails the computation of A^{b} mod m, where b and m are elements of the key and A is the data to be encrypted or decrypted.

“Symmetric key” means the key of a symmetric key cryptosystem. The symmetric key is used to encrypt a file or message and also to decrypt the file or message.

“Symmetric key cryptosystem” means a cryptosystem that uses one key to lock and unlock—encrypt and decrypt—messages and files. The sender must posses the key to encrypt a file or message, and the recipient(s) must possess the key to decrypt the file or message.

“Window width” means the number of exponent bits that are parsed at a time using the sliding window technique.

Any element in a claim that does not explicitly state “means for” performing a specified function, or “step for” performing a specific function, is not to be interpreted as a “means” or “step” clause as specified in 35 U.S.C. § 112, ¶ 6. In particular, the use of “step of” in the claims herein is not intended to invoke the provision of 35 U.S.C. § 112, ¶ 6.

It should be apparent from the foregoing that an invention having significant advantages has been provided. While the invention is shown in only a few of its forms, it is not limited to only those forms but is susceptible to various changes and modifications without departing from the spirit thereof.

What is claimed is:

1. A method of encrypting data, including exponentiating by iteratively cisponentiating according to cisponentiator C(G, E, B, R, m)=G^{E}BR mod m,
wherein G is a fleeting multiplicand base;
wherein E is an enduring cisponent;
wherein B is a recurring multiplier;
wherein R is an enduring factor; and
wherein m is a persistent modulus.

2. The method of claim 1, wherein the E is a fixed characteristic of the cisponentiator, whereby C_{E}(G, B, R, m)=C(G, E, B, R, m)=G^{E}BR mod m.

3. The method of claim 2, wherein the E is a power of 2.

4. The method of claim 1, wherein the R is fixed, whereby C_{R}(G, E, B, m)=C(G, E, B, R, m)=G^{E}BR mod m.

5. The method of claim 4, wherein the E is a fixed characteristic of the cisponentiator, whereby C_{ER}(G, B, m)=C(G, E, B, R, m)=G^{E}BR mod m.

6. The method of claim 5, wherein the E is a power of 2.

7. The method of claim 1, wherein m is fixed, whereby Cₘ(G, E, B, R)=C(G, E, B, R, m)=G^{E}BR mod m.

8. The method of claim 5, wherein m is fixed, whereby C_{ERm}(G, B)=C(G, E, B, R, m)=G^{E}BR mod m.

9. The method of claim 1, wherein the data is encrypted using asymmetric encryption.

10. The method of claim 5, wherein the data is encrypted using asymmetric encryption.

11. A method of key exchange, including exponentiating by iteratively cisponentiating according to cisponentiator C(G, E, B, R, m)=G^{E}BR mod m,
wherein G is a fleeting multiplicand base;
wherein E is an enduring cisponent;
wherein B is a recurring multiplier;
wherein R is an enduring factor; and
wherein m is a persistent modulus.

12. The method of claim 11, wherein the E is a fixed characteristic of the cisponentiator, whereby C_{E}(G, B, R, m)=C(G, E, B, R, m)=G^{E}BR mod m.

13. The method of claim 12, wherein the E is a power of 2.

14. The method of claim 11, wherein the R is fixed, whereby C_{R}(G, E, B, m)=C(G, E, B, R, m)=G^{E}BR mod m.

15. The method of claim 14, wherein the E is a fixed characteristic of the cisponentiator, whereby C_{ER}(G, B, m)=C(G, E, B, R, m)=G^{E}BR mod m.

16. The method of claim 15, wherein the E is a power of 2.

17. The method of claim 11, wherein m is fixed, whereby Cₘ(G, E, B, R)=C(G, E, B, R, m)=G^{E}BR mod m.

18. The method of claim 15, wherein m is fixed, whereby C_{ERm}(G, B)=C(G, E, B, R, m)=G^{E}BR mod m.

19. A software program configured to execute a method of encrypting data, including exponentiating by iteratively cisponentiating according to cisponentiator C(G, E, B, R, m)=G^{E}BR mod m,
wherein G is a fleeting multiplicand base;
wherein E is an enduring cisponent;
wherein B is a recurring multiplier;
wherein R is an enduring factor; and
wherein m is a persistent modulus.

20. The software program of claim 19,
wherein the R is fixed; and
wherein the E is a fixed characteristic of the cisponentiator; and
wherein the E is also a power of 2, whereby C_{ER}(G, B, m)=C(G, E, B, R, m)=G^{E}BR mod m.

21. A software program configured to execute a method of key exchange, including exponentiating by iteratively cisponentiating according to cisponentiator C(G, E, B, R, m)=G^{E}BR mod m,
wherein G is a fleeting multiplicand base;
wherein E is an enduring cisponent;
wherein B is a recurring multiplier;
wherein R is an enduring factor; and
wherein m is a persistent modulus.

22. The software program of claim 21,
wherein the R is fixed; and
wherein the E is a fixed characteristic of the cisponentiator; and
wherein the E is also a power of 2, whereby C_{ER}(G, B, m)=C(G, E, B, R, m)=G^{E}BR mod m.

23. A device for encrypting data, configured to exponentiate by iteratively cisponentiating according to cisponentiator C(G, E, B, R, m)=G^{E}BR mod m,
wherein G is a fleeting multiplicand base;
wherein E is an enduring cisponent;
wherein B is a recurring multiplier;
wherein R is an enduring factor; and
wherein m is a persistent modulus.

24. The device of claim 23, wherein the E is a fixed characteristic of the cisponentiator, whereby C_{E}(G, B, R, m)=C(G, E, B, R, m)=G^{E}BR mod m.

25. The device of claim 24, wherein the E is a power of 2.

26. The device of claim 23, wherein the R is fixed, whereby C_{R}(G, E, B, m)=C(G, E, B, R, m)=G^{E}BR mod m.

27. The device of claim 26, wherein the E is a fixed characteristic of the cisponentiator, whereby C_{ER}(G, B, m)=C(G, E, B, R, m)=G^{E}BR mod m.

28. The device of claim 27, wherein the E is a power of 2.

29. The device of claim 23, wherein m is fixed, whereby Cₘ(G, E, B, R)=C(G, E, B, R, m)=G^{E}BR mod m.

30. The device of claim 27, wherein m is fixed, whereby C_{ERm}(G, B)=C(G, E, B, R, m)=G^{E}BR mod m.

31. The device of claim 23, wherein the data is encrypted using asymmetric encryption.

32. The device of claim 27, wherein the data is encrypted using asymmetric encryption.

33. A device for exchanging keys, configured to exponentiate by iteratively cisponentiating according to cisponentiator C(G, E, B, R, m)=G^{E}BR mod m,
wherein G is a fleeting multiplicand base;
wherein E is an enduring cisponent;
wherein B is a recurring multiplier;
wherein R is an enduring factor; and
wherein m is a persistent modulus.

34. The device of claim 33, wherein the E is a fixed characteristic of the cisponentiator, whereby C_{E}(G, B, R, m)=C(G, E, B, R, m)=G^{E}BR mod m.

35. The device of claim 34, wherein the E is a power of 2.

36. The device of claim 33, wherein the R is fixed, whereby C_{R}(G, E, B, m)=C(G, E, B, R, m)=G^{E}BR mod m.

37. The device of claim 36, wherein the E is a fixed characteristic of the cisponentiator, whereby C_{ER}(G, B, m)=C(G, E, B, R, m)=G^{E}BR mod m.

38. The device of claim 37, wherein the E is a power of 2.

39. The device of claim 33, wherein m is fixed, whereby Cₘ(G, E, B, R)=C(G, E, B, R, m)=G^{E}BR mod m.

40. The device of claim 37, wherein m is fixed, whereby C_{ERm}(G, B)=C(G, E, B, R, m)=G^{E}BR mod m.

41. A method of processing data, including exponentiating by iteratively cisponentiating according to cisponentiator C(G, E, B, R, m)=G^{E}BR mod m,
wherein G is a fleeting multiplicand base;
wherein E is an enduring cisponent;
wherein B is a recurring multiplier;
wherein R is an enduring factor; and
wherein m is a persistent modulus.

42. The method of claim 41,
wherein the R is fixed; and
wherein the E is a fixed characteristic of the cisponentiator; and
wherein the E is also a power of 2, whereby C_{ER}(G, B, m)=C(G, E, B, R, m)=G^{E}BR mod m.

43. The method of claim 41, further comprising:
wherein the data is processed to produce nonlinear congruential pseudorandom numbers.
